(19) United States
(12) Patent Application Publication
(10) Pub. No.: US 2018/0293557 A1
(43) Pub. Date: Oct. 11, 2018

(54) METHOD OF CHARGING ELECTRONIC CURRENCY AUTOMATICALLY BASED ON BLOCKCHAIN AND SYSTEM THEREOF

(71) Applicant: SAMSUNG SDS CO., LTD., Seoul (KR)

(72) Inventors: Hyung Nam KIM, Seoul (KR); Ji Hwan RHIE, Seoul (KR); Heung Sik CHAE, Seoul (KR); Yeong Min SEO, Seoul (KR)

(73) Assignee: SAMSUNG SDS CO., LTD., Seoul (KR)

(21) Appl. No.: 15/942,094

(22) Filed: Mar. 30, 2018

(30) Foreign Application Priority Data
Apr. 5, 2017 (KR) 10-2017-0044430
Oct. 19, 2017 (KR) 10-2017-0135847

(51) Int. Cl. G06Q 20/06; G06Q 20/36; G06Q 20/14

(52) U.S. Cl. CPC G06Q 20/0658; G06Q 20/3825; G06Q 20/14; G06Q 20/36

(57) ABSTRACT

Provided is a blockchain-based electronic currency automatic charging method. The method comprises determining that an automatic charging of a charging amount of electronic currency to a payer is necessary, in response to receiving a payment transaction processing request from a terminal of the payer, wherein the payment transaction processing request is associated with a payment transaction and wherein the payment transaction processing request includes payment information, charging the charging amount of electronic currency in an electronic wallet of the payer in response to the determining, initiating a repayment transaction based on the payment information, wherein a repayment transaction message is associated with the repayment transaction, and wherein the repayment transaction message includes a first electronic signature and a second electronic signature, and wherein the first electronic signature is provided by a service-providing server, and wherein the second electronic signature is obtained from the payment information and processing the repayment transaction without requesting the terminal of the payer for an electronic signature for the repayment transaction message, wherein the processing includes interoperating with a blockchain network formed of a plurality of blockchain nodes.

This application claims priority from Korean Patent Application No. 10-2017-0044430 filed on Apr. 5, 2017 and No. 10-2017-0135847 filed on Oct. 19, 2017 in the Korean Intellectual Property Office, the disclosure of both of which are hereby incorporated by reference in their entirety.

### BACKGROUND

### 1. Field of the Disclosure

The present disclosure relates to a method of charging an electronic currency automatically based on a blockchain and a system thereof, and more particularly, to an automatic charging method devised to solve a problem of low user convenience in providing a service for charging electronic currency automatically based on a blockchain, and a system for performing the same.

### 2. Description of the Related Art

A blockchain refers to data management technology, in which continuously growing data is recorded in certain units of block and nodes of a peer-to-peer (P2P) network managing the blocks in a chain-form data structure, or refers to data itself of the chain-form data structure. In this case, blockchain data of the chain-form data structure is managed in the form of a distributed ledger at each individual node, without a central system.

Each individual blockchain node of a blockchain network manages blocks in a data structure such as that illustrated in FIG. 1. Here, each block is recorded with a hash value of a previous block, so that the previous block can be referred to by the hash value. Therefore, as more blocks are added, it becomes difficult to forge transaction data recorded in the block, and the transaction data recorded in each block is improved in reliability.

A transaction processing system based on the above blockchain processes a transaction requested according to, for example, the procedure shown in FIG. 2. Referring to FIG. 2, when a transaction processing request is received from a payer terminal of an electronic currency (\textcircled{1}), validity verification for a transaction is performed to prevent double-spending or the like (\textcircled{2}), and transaction data is transmitted to a block creating node in the case of a valid transaction (\textcircled{3}). Next, the block creating node records the transaction data in a new block (\textcircled{4}), and the new block is spread over the blockchain network to achieve a distribution consensus (\textcircled{5}). When the transaction is finally confirmed by the distribution consensus, a predetermined electronic currency is transferred from an electronic wallet of a payer to an electronic wallet of a payee (\textcircled{6}).

With the foregoing procedure, the blockchain-based system has advantages of providing a safe transaction service between parties concerned with the transaction without a central management system. However, in the blockchain-based system in accordance with the above procedure, when the electronic currency automatic charging service triggered by insufficient balance of an electronic currency is provided, a problem of low user convenience occurs as below.

First, the problem of low user convenience occurs due to lead time taken for a payment transaction to be processed again after automatic charging. For example, when it is assumed that a user's point balance stored in an electronic wallet is 7,000 points, and a payment amount is 10,000 points, at least 3,000 points has to be automatically charged, and the payment has to be performed again after the automatic charging is completed. However, in the above-described blockchain transaction processing procedure, a standby time is required until block mining is successful, for the automatic charging to be completed. For example, because it takes an average of 10 minutes for block mining in a bitcoin blockchain, 10 minutes of standby time may be generated until the automatic charging is completed. Because more standby time is required for block mining for the transaction of the repayment to be approved of, about 20 minutes of lead time may be generated until the repayment is completed in the case of the bitcoin blockchain. Such generation of lead time may considerably lower the convenience of a user who uses the automatic charging service for instant payment processing.

Second, the problem of low user convenience occurs due to an electronic signature being repeatedly requested for in a transaction. After automatic charging is performed, a repayment transaction has to be newly created for a payment to be performed again. Although payment information to be included in the repayment transaction may be immediately acquired from an existing payment transaction, an electronic signature has to be performed again for the repayment transaction due to characteristics of a blockchain. Accordingly, because a payer has to perform an electronic signature again every time the automatic charging occurs, user convenience may be lowered due to repeatedly making an electronic signature.

### SUMMARY

It is an aspect of the present disclosure to provide a method of charging an electronic currency automatically based on a blockchain and a system for performing the same.

It is another aspect of the present disclosure to provide a blockchain-based electronic currency automatic charging method for minimizing lead time taken for automatic charging and a repayment transaction to be approved, and a system for performing the same.

It is still another aspect of the present disclosure to provide a blockchain-based electronic currency automatic charging method for processing a repayment transaction without requesting for an electronic signature of a payer, and a system for performing the same.

According to an aspect of the present disclosure, there is provided a blockchain-based electronic currency automatic charging method. The blockchain-based electronic currency automatic charging method comprises determining that an automatic charging of a charging amount of electronic currency to a payer is necessary, in response to receiving a payment transaction processing request from a terminal of the payer, wherein the payment transaction processing request is associated with a payment transaction and wherein the payment transaction processing request includes payment information, charging the charging amount of electronic currency in an electronic wallet of the payer in response to the determining, initiating a repayment transaction based on the payment information, wherein a repayment transaction message is associated with the repayment transaction, and wherein the repayment transaction message includes a first electronic signature and a second electronic signature, and wherein the first electronic signature is provided by a service-providing server, and wherein the second electronic signature is obtained from the payment information and processing the repayment transaction without requesting the terminal of the payer for an electronic signature for the repayment transaction message, wherein the processing includes interoperating with a blockchain network formed of a plurality of blockchain nodes.

According to another aspect of the present disclosure, there is provided a service-providing server comprising a hardware processor, a network interface, a memory configured to load a computer program to be executed by the hardware processor and a storage configured to store the computer program, wherein the computer program which, when executed by the hardware processor, causes the hardware processor to perform operations comprising determining that an automatic charging of a charging amount of electronic currency held by a payer is necessary, in response to a payment transaction processing request received from a terminal of the payer, wherein the payment transaction processing request is associated with a payment transaction and wherein the payment transaction processing request includes payment information, charging the charging amount of electronic currency in an electronic wallet of the payer in response to the determining, initiating a repayment transaction based on the payment information, wherein a repayment transaction message is associated with the repayment transaction, and wherein the repayment transaction message includes a first electronic signature and a second electronic signature, and wherein the first electronic signature is provided by the service-providing server, and wherein the second electronic signature is obtained from the payment transaction and processing the repayment transaction without requesting the terminal of the payer for an electronic signature for the repayment transaction message, wherein the processing includes interoperating with a blockchain network formed of a plurality of blockchain nodes.

According to still another aspect of the present disclosure, there is provided a non-transitory computer-readable storage medium storing a computer program which, when executed by at least one processor of a service-providing server, causes the service-providing server to perform operations comprising determining that an automatic charging of a charging amount of electronic currency to a payer is necessary, in response to a payment transaction processing request received from a terminal of the payer, wherein the payment transaction processing request is associated with a payment transaction and wherein the payment transaction processing request includes payment information, charging the charging amount of electronic currency in an electronic wallet of the payer in response to the determining, initiating a repayment transaction based on payment information, where a repayment transaction message is associated with the repayment transaction, and wherein the repayment transaction message includes a first electronic signature and a second electronic signature, and wherein the first electronic signature is provided by the service-providing server, and the second electronic signature is obtained from the payment information and processing the repayment transaction without requesting the terminal of the payer for an electronic signature for the repayment transaction, wherein the processing includes interoperating with a blockchain network formed of a plurality of blockchain nodes.

It should be noted that objects of the present disclosure are not limited to the above-described objects, and other objects of the present disclosure will be apparent to those skilled in the art from the following descriptions.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a view illustrating a structure of blockchain data that may be referred to in some exemplary embodiments of the present disclosure;

FIG. 2 is a diagram illustrating a transaction processing procedure performed in a conventional blockchain-based system;

FIG. 3 is a block diagram of a blockchain-based electronic currency automatic charging system according to an embodiment of the present disclosure;

FIGS. 4A and 4B are diagrams for comparing and illustrating procedures of processing transactions requested by an authenticated user and an unauthenticated user in the blockchain-based electronic currency automatic charging system;

FIGS. 5A and 5B are conceptual diagrams illustrating procedures in which an automatic charging transaction and a repayment transaction are processed in the blockchain-based electronic currency automatic charging system;

FIG. 6 is an exemplary block diagram of a service providing server (100), which is one element of the blockchain-based electronic currency automatic charging system;

FIG. 7 is a hardware configuration diagram of the service providing server (100), which is one element of the blockchain-based electronic currency automatic charging system;

FIG. 8 is a flowchart of a blockchain-based electronic currency automatic charging method according to an embodiment of the present disclosure;

FIGS. 9A to 9C are diagrams illustrating a multiple-signature technique that may be referred to in some exemplary embodiments of the present disclosure;

FIGS. 10 and 11 are diagrams illustrating a repayment transaction creating method that may be referred to in some exemplary embodiments of the present disclosure; and

FIG. 12 is a flowchart of the blockchain-based electronic currency automatic charging method according to the embodiment of the present disclosure from the viewpoint of the blockchain-based electronic currency automatic charging system.

### DETAILED DESCRIPTION OF THE EMBODIMENTS

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Prior to the description of this specification, some terms used in this specification will be defined.

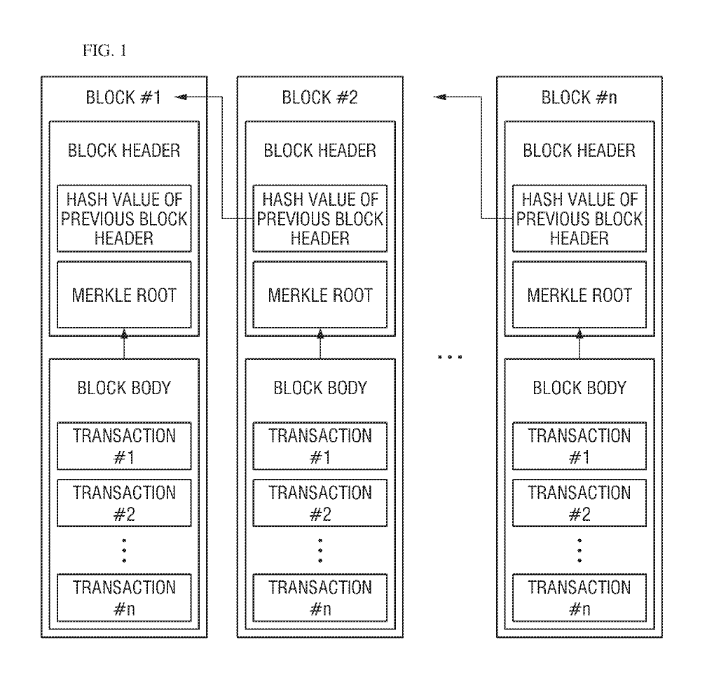

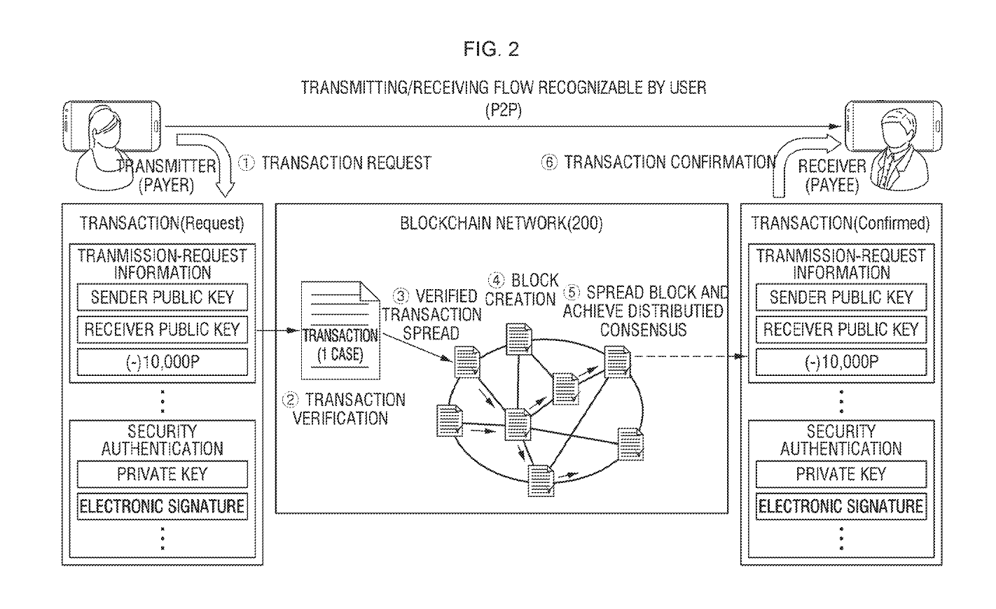

In this specification, blockchain data or blockchain itself refers to data in which each individual blockchain node of a blockchain network is maintained, and indicates data in which at least one block is configured in a chain-form data structure. When data recorded in each individual block is transaction data, the blockchain data may be used as a distributed ledger. However, the kind of data to be recorded in each individual block may vary as desired. The structure of the blockchain data is illustrated in FIG. 1.

In this specification, the blockchain network refers to a network of a peer-to-peer (P2P) structure having a plurality of blockchain nodes that operates in accordance with a blockchain algorithm.

In this specification, the blockchain node refers to a computing node which forms the blockchain network and maintains and manages blockchain data on the basis of a blockchain algorithm. Each individual blockchain node may be implemented by a single physical computing apparatus, but may also be implemented using a single logical computing apparatus such as a virtual machine. When the virtual machine is used as the blockchain node, a plurality of blockchain nodes may be present in an independent physical computing apparatus.

In this specification, a block creating node refers to a node for creating new blocks through a block creating operation in accordance with a blockchain algorithm, like mining, among the blockchain nodes of the blockchain network.

In this specification, permission may be understood as a comprehensive concept including authentication and authorization.

Some exemplary embodiments of the present disclosure will be described below in detail with reference to the accompanying drawings.

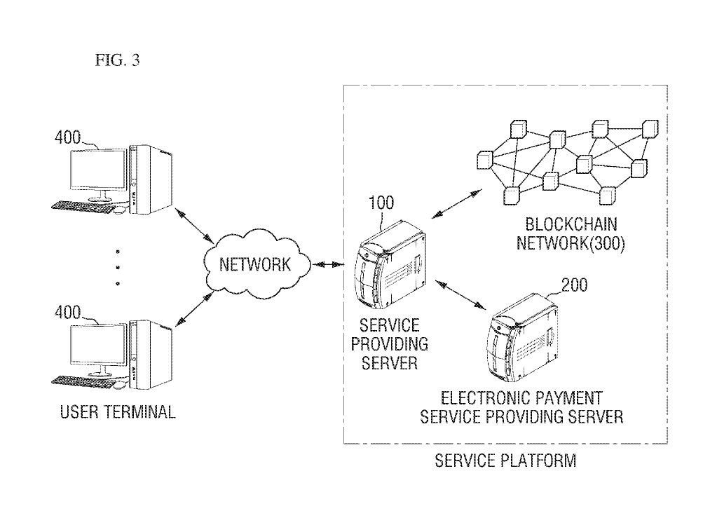

FIG. 3 is a configuration view of a blockchain-based electronic currency automatic charging system according to an embodiment of the present disclosure.

Referring to FIG. 3, the blockchain-based electronic currency automatic charging system may include a service providing serer 100, an electronic payment service providing server 200, a blockchain network 300, and a user terminal 400. However, this is merely an exemplary embodiment for achieving an object of the present disclosure, and some elements may be included or excluded if necessary. Further, the elements of the blockchain-based electronic currency automatic charging system illustrated in FIG. 3 indicate functional elements that are classified by function, and it will be appreciated that at least one element may be given in combination form in a real physical environment. For example, the service providing server 100 and the electronic payment service providing server 200 may be achieved by a single physical computing apparatus. However, the service providing server 100 and/or the electronic payment service providing server 200 may also be achieved by at least one blockchain node of the blockchain network 300. The elements of the blockchain-based electronic currency automatic charging system will be described below.

In the blockchain-based electronic currency automatic charging system, the service providing server 100 is a computing apparatus that interoperates with the blockchain network 300 and the electronic payment service providing server 200 to provide an electronic currency automatic charging service. Here, the computing apparatus may include a notebook computer, a desktop computer, a laptop computer, etc. without limitation, and may include any kind of apparatus including an operating unit and a communicating unit. The electronic currency may be, for example, a virtual currency, a custom currency, or the like. However, for convenience in understanding, unless particularly mentioned otherwise, description will be given by assuming that the electronic currency is predetermined points, as an example. However, the above example is merely for describing some exemplary embodiments of the present disclosure, and the scope of the present disclosure is not limited to a particular type of electronic currency.

The service providing server 100 receives a payment transaction processing request from the terminal 400 of a user who uses an automatic charging service, and determines whether automatic charging is necessary. In response to the determination of whether automatic charging is necessary, the service providing server 100 automatically creates a transaction for automatically charging points and processes the created automatic charging transaction by interoperating with the blockchain network 300.

Further, the service providing server 100 creates a repayment transaction on the basis of payment information included in the payment transaction and processes the repayment transaction by interoperating with the blockchain network 300.

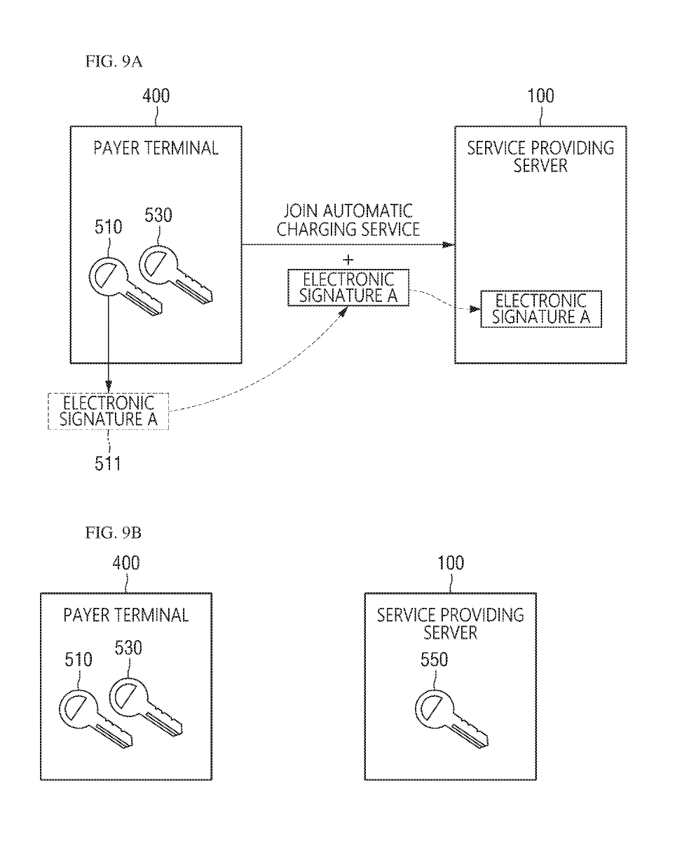

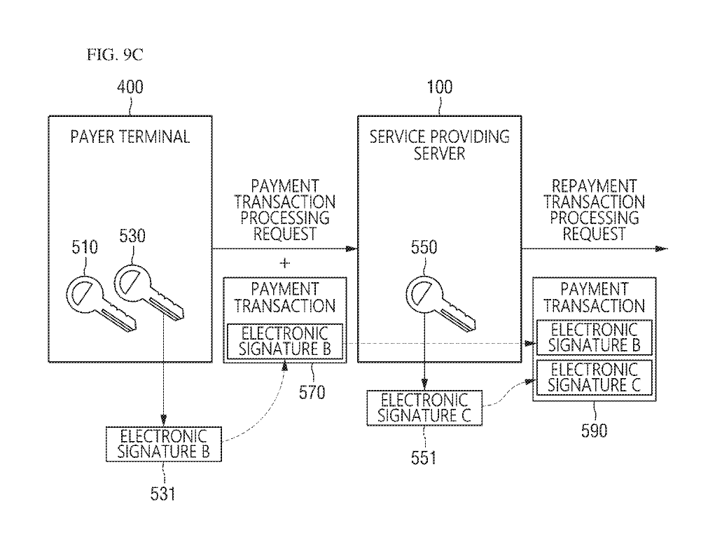

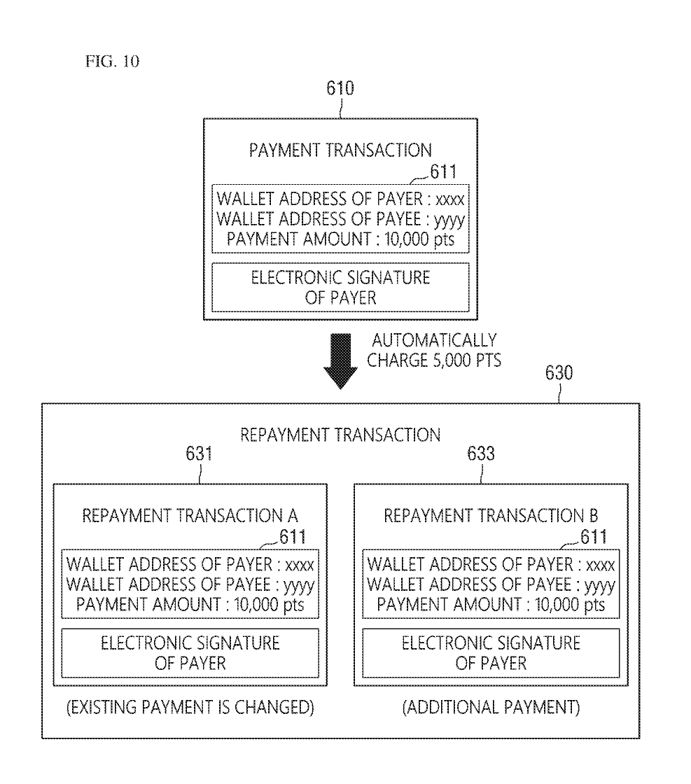

According to an embodiment of the present disclosure, the service providing server 100 may process the repayment transaction without requesting for an electronic signature of the user for the repayment transaction by utilizing a multiple-electronic signature technique. This embodiment will be described below with reference to drawings such as FIGS. 9A to 9C.

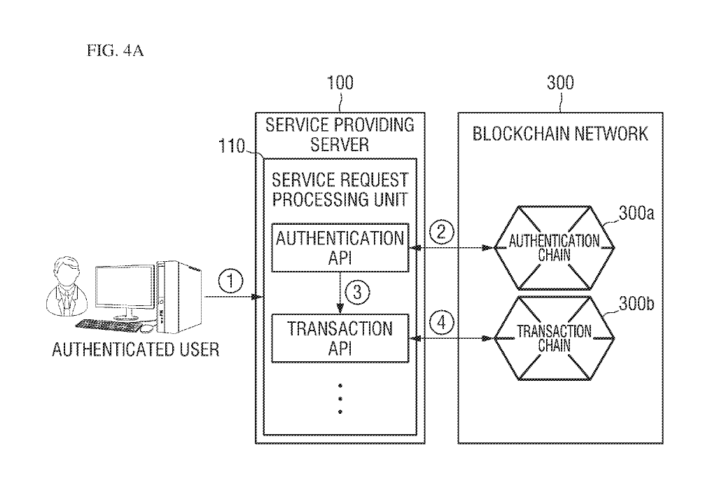

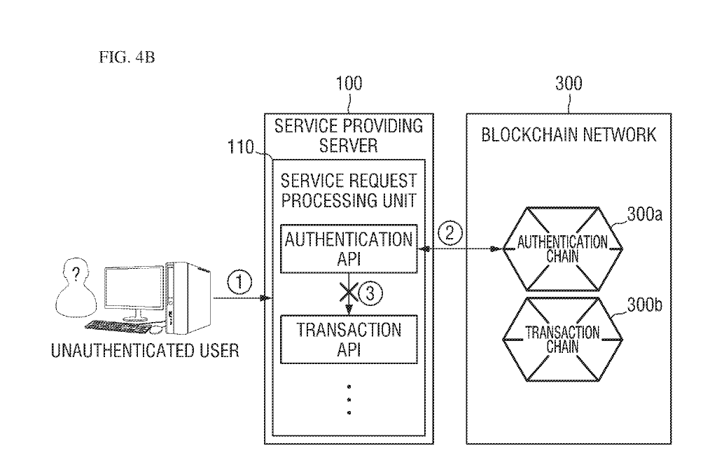

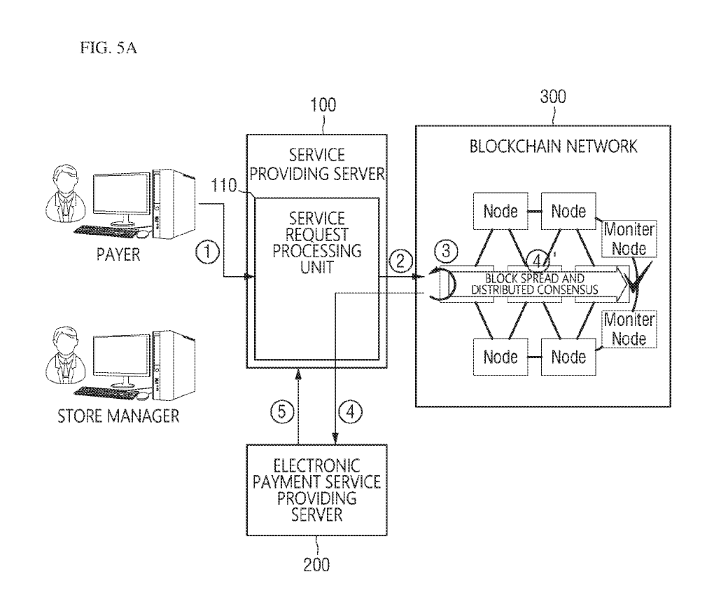

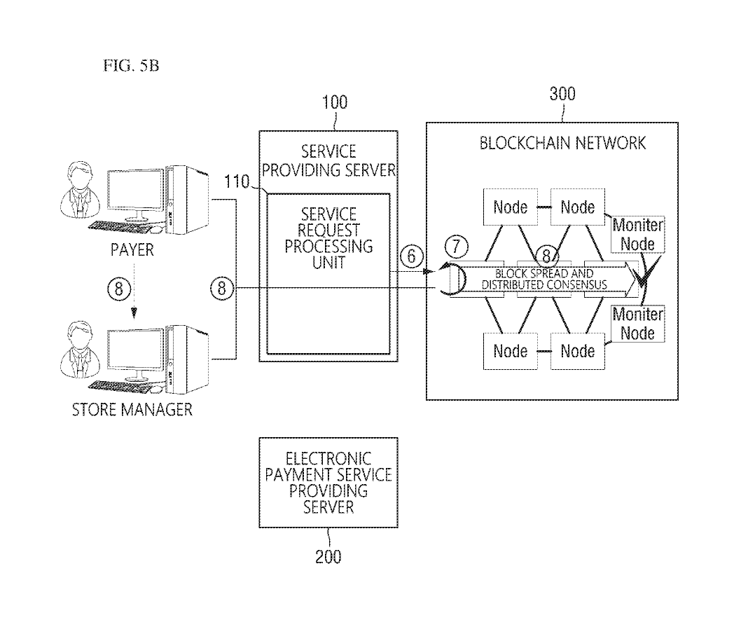

According to an embodiment of the present disclosure, the service providing server 100 may minimize lead time taken for processing an automatic charging transaction and a repayment transaction on the basis of reliability secured through a permission-based blockchain network. This embodiment will be described below with reference to drawings such as FIGS. 4A to 5B.

In the blockchain-based electronic currency automatic charging system, the electronic payment service providing server 200 is a computing apparatus for processing an electronic payment of commodity currency corresponding to automatically-charged points in response to a request from the service providing server 100. Here, the computing apparatus may include a notebook computer, a desktop computer, a laptop computer, etc. without limitation, and may include any kind of apparatus including an operating unit and a communicating unit.

The electronic payment service providing server 200 may process an electronic payment by, for example, account transfer, card payment, or the like, but the electronic payment service providing server 200 may use any method.

In the blockchain-based electronic currency automatic charging system, the blockchain network 300 may include a plurality of blockchain nodes that operate in accordance with a blockchain algorithm. In response to the transaction processing request from the service providing server 100, the plurality of blockchain nodes verify the validity of the transaction, record the verified transaction in a new block, and spreads the new block over the blockchain network 300. Each individual blockchain node maintains the same blockchain data.

According to an embodiment of the present disclosure, the blockchain network 300 may be implemented by a permission-based blockchain network. That is, the blockchain network 300 may be a restricted network in which only permission-verified participants (e.g., users, blockchain nodes) can participate. Here, the permission-based blockchain network may be used along with the term ‘private blockchain network’ or the like in the art, which may have the same meaning. According to the exemplary embodiment, participation of unspecified nodes and requests from non-permitted users may be restricted. That is, reliability of users using the automatic charging service, various transactions requested by the users, and blockchain nodes processing the transactions may be secured in advance. Accordingly, it is possible to alleviate excessive requirements for proof of work needed to create a block and also to immediately process a requested transaction on the basis of the secured reliability. This embodiment will be additionally described in detail with reference to FIGS. 4A to 5B.

According to an embodiment of the present disclosure, the blockchain network 300 may distribute and store first blockchain data and second blockchain data configured separately from the first blockchain data in blockchain nodes. Here, the first blockchain data may refer to an authentication blockchain in which permission information of users and blockchain nodes is recorded, and the second blockchain data may refer to a transaction blockchain in which transaction data is recorded. That is, the blockchain network 300 may manage pieces of data having different uses using different blockchains. The first blockchain data may be used for verifying permission in the permission-based blockchain network 300, and the second blockchain data may be used for processing a transaction. This embodiment will be additionally described with reference to FIGS. 4A and 4B.

According to an embodiment of the present disclosure, at least one node among the plurality of blockchain nodes forming the blockchain network 300 may be a monitoring node. The monitoring node refers to a special type of node for monitoring states and operations of other blockchain nodes. Particularly, the monitoring node may monitor new block creation of block creating nodes among the plurality of blockchain nodes. Specifically, the monitoring node may receive a new block spread over the blockchain network 300, and in response to receiving the new block, calculate a block creation time on the basis of a time-stamp value recorded in the new block. For example, when, after a first block having a block number k (where k is a natural number equal to or greater than 1), a second block having a block number k+1 is received, the monitoring node may calculate a block creation time on the basis of a difference between a first time stamp recorded in the first block and a second time stamp recorded in the second block. The calculated block creation time may be transmitted to a blockchain management apparatus (not illustrated) and be used in controlling the block creation time by the blockchain management apparatus (not illustrated).

For example, the blockchain management apparatus (not illustrated) may receive a block creation time from the monitoring node, calculate an average block creation time, and compare the average block creation time with a target time. Further, by adjusting the level of difficulty of block creation according to a result of the comparison, the blockchain management apparatus (not illustrated) may control a block creation time of the blockchain network 300 in accordance with a preset target time. As reference, when the blockchain network 300 is formed as a permission-based blockchain network, the blockchain management apparatus (not illustrated) may reduce time taken for confirming a transaction by setting the target time as a small value.

In the blockchain-based electronic currency automatic charging system, the user terminal 400 is a terminal of a user using the blockchain-based automatic charging service and transaction processing service. The user is one of parties concerned with a transaction and may be, for example, a payer who purchases goods from a store and pays for the goods using points. Hereinafter, unless mentioned otherwise, the user will be assumed as a payer, and the user terminal 400 will be referred to as a payer terminal.

An electronic wallet application that provides various transaction processing services through the blockchain network 300 may be installed in the payer terminal 400. An application programming interface (API) key may be issued by the service providing server 100 and/or the blockchain management apparatus (not illustrated) for verifying permission of the electronic wallet application. The issued API key may be recorded in blockchain data managed by each individual blockchain node and be used in verifying permission of the application.

The elements of the blockchain-based electronic currency automatic charging system illustrated in FIG. 3 may communicate through a network. Here, the network may be implemented by any kinds of wired/wireless networks such as a local area network (LAN), a wide area network (WAN), a mobile radio communication network, wireless broadband Internet (WiBro), etc.

The blockchain-based electronic currency automatic charging system according to an embodiment of the present disclosure has been described with reference to FIG. 3. Procedures in which a payment transaction and an automatic charging transaction are processed in the blockchain-based electronic currency automatic charging system will be described below with reference to FIGS. 4A to 5B.

FIGS. 4A and 4B are diagrams for comparing and illustrating procedures of processing payment transactions requested by an authenticated user and an unauthenticated user. Specifically, FIG. 4A shows a procedure in which a payment transaction requested by an authenticated user (hereinafter referred to as a “first payer”) is processed, and FIG. 4B shows a procedure in which a payment transaction requested by an unauthenticated user (hereinafter referred to as a “second payer”) is processed.

First, referring to FIG. 4A, the service providing server 100 performs permission verification on the first payer (\textcircled{2}) in response to a payment transaction processing request received from a terminal of the first payer (\textcircled{1}). The permission verification may be performed on the basis of permission information recorded in an authentication blockchain 300a.

Specifically, the service providing server 100 may receive identification information of the first payer along with the payment transaction processing request, acquire the permission information of the first payer from the authentication blockchain 300a by means of the received identification information, and perform permission verification on the first payer through the acquired permission information of the first payer. In this case, the identification information may be an ID, the user's name, an electronic signature, etc., and the permission information recorded in the authentication blockchain 300a may be a public key, a certificate, a password, etc., which may vary depending on the implementation of the system. As reference, when a public key of the user is used as the permission information, the permission verification may be performed by verifying an electronic signature of the first payer, which is included in the payment transaction.

According to an embodiment of the present disclosure, the service providing server 100 may additionally perform permission verification on an application installed in the terminal of the first payer. Specifically, the service providing server 100 may receive API key information of an electronic wallet application installed in the terminal of the first payer along with the payment transaction processing request and may perform permission verification on the electronic wallet application by verifying whether the received API key information is recorded in the authentication blockchain 300a. That is, the API key information of the electronic wallet application may be configured in a white list and then distributed and stored in the authentication blockchain 300a, and the permission verification may be performed on the electronic wallet application by using the white list. Depending on the embodiment, the API key information of the electronic wallet application may also be configured in a black list and then distributed and stored in the authentication blockchain 300a.

In this way, when the permission of the first payer and/or the electronic wallet application installed in the terminal of the first payer is verified, the service providing server 100 processes the payment transaction requested by the terminal of the first payer (\textcircled{3}, \textcircled{4}). In this case, data of the requested payment transaction may be recorded in a transaction blockchain 300b configured as a chain separate from the authentication blockchain 300a. As reference, the authentication blockchain 300a and the transaction blockchain 300b may be distributed and managed by the same blockchain node or by at least partially different blockchain nodes. This may vary depending on the embodiment as desired.

Subsequently, a case in which a payment transaction processing request is received from a terminal of the second payer, who is an unauthenticated user, will be described with reference to FIG. 4B.

Referring to FIG. 4B, the service providing server 100 performs permission verification on the second payer (\textcircled{2}) in response to a payment transaction processing request received from the terminal of the second payer (\textcircled{1}). The permission verification may include permission verification for the second payer and/or permission verification for an electronic wallet application installed in the terminal of the second payer, as described above.

A result of the permission verification is that authentication fails or the second payer has no authority. In this case, the payment transaction processing request from the second payer is rejected (\textcircled{3}).

The procedures in which transactions requested by an authenticated user and an unauthenticated user are processed in the permission-based blockchain network have been compared and illustrated with reference to FIGS. 4A and 4B. As described above, permission verification is performed on users and then performed on applications installed in user terminals. Only transactions requested by reliable users and applications may be processed through the permission verification. Accordingly, it is possible to secure reliability of transactions that are processed through the blockchain network 300.

Next, procedures in which an automatic charging transaction and a repayment transaction are processed will be described in further detail with reference to FIGS. 5A and 5B. The automatic charging transaction is a transaction for automatically charging points when a payment transaction having passed the permission verification cannot be processed due to insufficient balance. The repayment transaction is a transaction for performing a payment again after automatic charging is completed.

Referring to FIG. 5A, in response to receiving a payment transaction processing request from a payer terminal, the service providing server 100 first determines whether automatic charging is necessary (\textcircled{1}).

In one embodiment, a logic for determining whether automatic charging is necessary may be performed by interoperating with the blockchain network 300. The determination logic will be described in detail. The service providing server 100 transfers a requested payment transaction to a first blockchain node among the plurality of blockchain nodes that constitute the blockchain network 300, particularly, that distribute and manage the transaction blockchain 300b, and performs a first process of acquiring a validity verification result for the requested payment transaction from the first blockchain node (\textcircled{2}, \textcircled{3}). When the validity verification result indicates that the requested payment transaction is invalid due to insufficient points, the service providing server 100 may determine that automatic charging is necessary.

In one embodiment, a logic for determining whether automatic charging is necessary may be performed by the service providing server 100 itself without interoperation with the blockchain network 300. The determination logic will be described in detail. The service providing server 100 may check balance in an electronic wallet of the first payer and compare the balance with a payment amount included in a payment transaction to determine whether automatic charging is required.

In response to the determination of whether automatic charging is necessary, the service providing server 100 requests the electronic payment service providing server 200 for an electronic payment in commodity currency and performs a second-1 process of acquiring an electronic payment processing result corresponding to the request (\textcircled{4}, \textcircled{5}). Subsequently, the service providing server 100 performs a second-2 process in which an electronic currency is charged in an electronic wallet of the payer on the basis of the electronic payment processing result.

Also, a second blockchain node among the plurality of blockchain nodes records data for the automatic charging transaction in a new block of a transaction blockchain and performs a third process in which the new block is spread over the blockchain network (\textcircled{4}′). A process \textcircled{4} and a process \textcircled{4}′ may be performed simultaneously.

In this way, according to an embodiment of the present disclosure, the second-1 and second-2 processes and the third process may be processed in parallel. Accordingly, even before the data for the automatic charging transaction is recorded in the new block, the automatic charging transaction may be immediately processed. Alternatively, the second-2 process and the third process may be processed in parallel after the payment in commodity currency is normally processed.

Next, referring to FIG. 5B, the service providing server 100 creates a repayment transaction to proceed with a requested payment again after automatic charging is completed. Here, an electronic signature for the repayment transaction is performed using an electronic signature and private key of a payer prestored in the service providing server 100. A method of creating the repayment transaction will be described in detail with reference to FIGS. 9A to 11.

Next, the service providing server 100 transfers the repayment transaction to a first blockchain node among the plurality of blockchain nodes that constitute the blockchain network 300, particularly, that distribute and manage the transaction blockchain 300b, and performs a first process of acquiring a validity verification result for the repayment transaction from the first blockchain node (\textcircled{6}, \textcircled{7}).

In response to acquisition of a verification result that indicates that the repayment transaction is valid, the service providing server 100 performs a second process that allows an electronic currency to be transferred from an electronic wallet of the payer to an electronic wallet of a store manager, and sends a message notifying of transaction processing completion to terminals of the payer and the store manager (\textcircled{8}).

Also, a second blockchain node or the like among the plurality of blockchain nodes that constitute the blockchain network 300, particularly, that distribute and manage the transaction blockchain 300b, records data for the repayment transaction in a new block and performs a third process in which the new block is spread over the blockchain network 300 (\textcircled{8}).

In this way, according to an embodiment of the present disclosure, the second process and the third process may be processed in parallel. Accordingly, even before the data for the repayment transaction is recorded in the new block, the repayment transaction may be immediately processed. Therefore, lead time taken for processing of a payment transaction to be completed may be minimized, and service satisfaction and convenience of a user may be improved.

Meanwhile, according to an embodiment of the present disclosure, permission verification on a block creating node may be performed in a procedure in which the third process, in which the automatic charging transaction or the repayment transaction is recorded and spread, is processed.

The procedure will be described in detail. A block creating node having created a new block through a mining process records its permission information (e.g., electronic signature information) along with data for a transaction in the new block and spreads the new block. As the new block is spread over the blockchain network 300, the blockchain node having received the new block may compare the permission information recorded in the new block with permission information of a white list for the block creating node and determine whether to add the new block. Here, the white list of the block creating node may be prestored in the authentication blockchain 300b. According to this embodiment, each individual blockchain node may be operated to add only new blocks created by authenticated and/or authorized block creating nodes to blockchain data. Accordingly, reliability of each block added to the blockchain data may be secured in advance.

The procedure of processing each transaction in the blockchain-based electronic currency automatic charging system has been described above with reference to FIGS. 4A to 5B. According to the above description, in the permission-based blockchain network according to the embodiment of the present disclosure, only transactions requested using reliable applications by reliable users may be processed. Also, only new blocks created by reliable block creating nodes may be added to blockchain data. Therefore, it is predicted that a transaction verified as valid through the blockchain data by a specific blockchain node would be verified as a valid transaction also by other blockchain nodes. Further, it is predicted that a validity-verified transaction would necessarily be recorded in blockchain data. Accordingly, the validity-verified transaction may be immediately processed under the prediction that the transaction would necessarily be recorded in the blockchain data, and lead time normally generated in a blockchain-based system may be minimized.

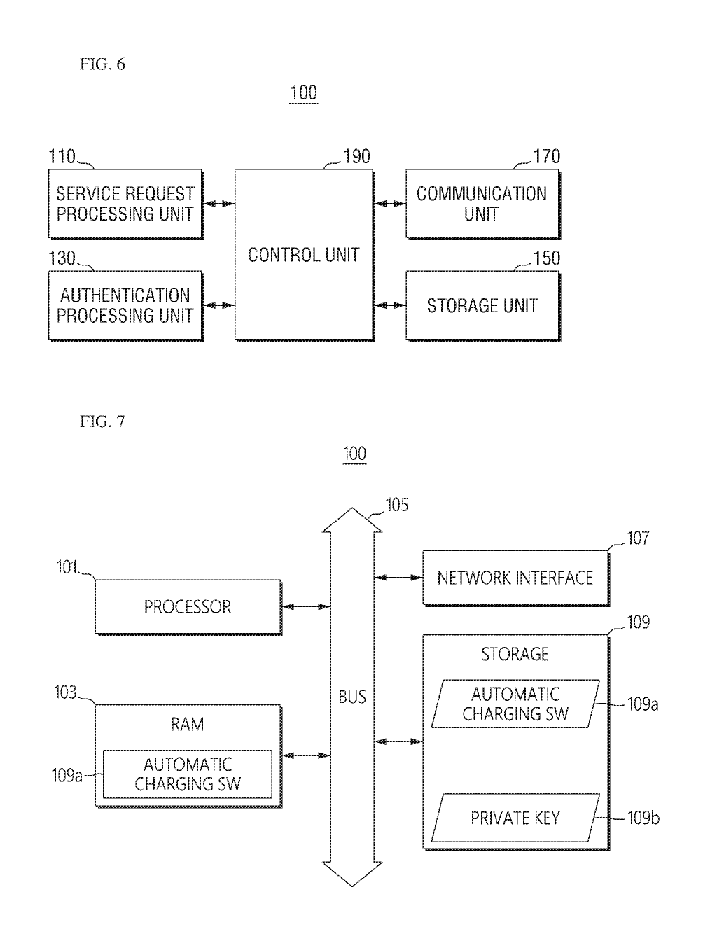

Hereinafter, a configuration and operation of the service providing server 100, which is one element of the blockchain-based electronic currency automatic charging system according to the embodiment of the present embodiment will be described with reference to FIGS. 6 and 7.

First, FIG. 6 is an exemplary block diagram of the service providing server 100 according to an embodiment of the present disclosure.

Referring to FIG. 6, the service providing server 100 may include a service request processing unit 110, an authentication processing unit 130, a storage unit 150, a communication unit 170, and a control unit 190. However, only elements associated with this embodiment of the present disclosure are shown in FIG. 6. Therefore, those skilled in the art will understand that other general-purpose elements may be provided in addition to the elements shown in FIG. 6. Further, the elements of a payment service providing server shown in FIG. 6 indicate functional elements that are classified by function, and it will be appreciated that at least one element may be given in combination form in a real physical environment.

The elements are as follows. The service request processing unit 110 receives various requests from the payer terminal 400 and provides results corresponding to the requests. For example, the service request processing unit 110 interoperates with the blockchain network 300 to process a payment transaction received from the payer terminal 400.

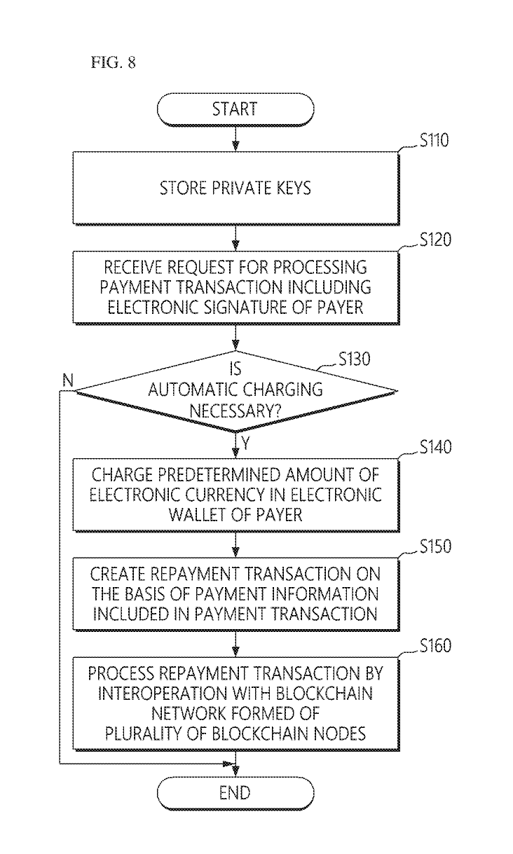

Specifically, the service request processing unit 110 performs permission verification on a payer and/or an application installed in the payer terminal 400 in response to a payment transaction processing request received from the payer terminal 400, and processes a requested payment transaction through the blockchain network 300 when the permission verification is successful. The description thereof is the same as described above, and thus will be omitted to avoid repetitive description. The operation of the service request processing unit 110 will be further described with additional reference to FIGS. 8 to 12.

The authentication processing unit 130 provides a function for authenticating a payer. For example, when an automatic charging service is provided only to joined members, the authentication processing unit 130 performs authentication on a payer having requested for a payment transaction that requires automatic charging. In this case, the service request processing unit 110 may be operated to provide the automatic charging service only when authentication is successful. Any method may be used for the authentication.

The storage unit 150 may non-temporarily store one or more computer programs for performing various operations of the service providing server 100. The storage unit 150 may include a nonvolatile memory such as a read only memory (ROM), an erasable programmable ROM (EPROM), an electrically erasable programmable ROM (EEPROM), a flash memory, etc., a hard disk drive, a detachable disk drive, or any computer-readable recording medium well-known in the technical field of the present disclosure.

The communication unit 170 performs data communication with other elements of the blockchain-based electronic currency automatic charging system. To this end, the communication unit 170 may include a wired Internet module, a mobile communication module, or a wireless communication module.

The control unit 190 controls the entire operation of the elements of the service providing server 100. The control unit 190 may include a central processing unit (CPU), a microprocessor unit (MPU), a microcontroller unit (MCU), or any processor well-known in the technical field of the present disclosure. Further, the control unit 190 may perform an operation for at least one application or program to implement the method according to the foregoing exemplary embodiments of the present disclosure.

The elements of FIG. 6 may indicate software elements or hardware elements such as a field programmable gate array (FPGA) or an application-specific integrated circuit (ASIC). However, the elements are not limited to software or hardware elements, but may be configured to be in a storage medium capable of being addressed or configured to run one or more processors. The functions provided in the foregoing elements may be achieved with more subdivided elements, and may be achieved by one element for performing a specific function by combining a plurality of elements.

FIG. 7 is a hardware configuration diagram of the service providing server 100 according to another embodiment of the present disclosure.

Referring to FIG. 7, the service providing server 100 may include one or more processors 101, a bus 105, a network interface 107, a memory 103 configured to load a computer program to be executed by the processor 101, and a storage 109 configured to store blockchain-based electronic currency automatic charging software 109a. However, only elements associated with this embodiment of the present disclosure are shown in FIG. 7. Therefore, those skilled in the art will understand that other general-purpose elements may be provided in addition to the elements shown in FIG. 7.

The processor 101 controls the entire operation of the elements of the service providing server 100. The processor 101 may include a CPU, a MPU, a MCU, a graphic processing unit (GPU), or any processor well-known in the technical field of the present disclosure. Further, the processor 101 may perform an operation for at least one application or program to implement the method according to the foregoing exemplary embodiments of the present disclosure. The service providing server 100 may include one or more processors.

The memory 103 stores various kinds of data, commands, and/or information. The memory 103 may load one or more programs 109a from the storage 109 to implement the blockchain-based electronic currency automatic charging method according to exemplary embodiments of the present disclosure. As an example of the memory 103, a RAM is shown in FIG. 7.

The bus 105 provides a communication function between the elements of the service providing server 100. The bus 105 may be implemented as various buses such as an address bus, a data bus, and a control bus.

The network interface 107 supports wired/wireless Internet communication of the service providing server 100. Also, the network interface 107 may support various communication methods in addition to Internet communication. To this end, the network interface 107 may include a communication module well-known in the technical field of the present disclosure.

The storage 109 may non-temporarily store a private key 109b used in an electronic signature for a repayment transaction and the one or more programs 109a. As an example of the one or more programs 109a, the blockchain-based electronic currency automatic charging software 109a is shown in FIG. 7.

The storage 109 may include a nonvolatile memory such as a ROM, an EPROM, an EEPROM, a flash memory, etc., a hard disk drive, a detachable disk drive, or any computer-readable recording medium well-known in the technical field of the present disclosure.

The blockchain-based electronic currency automatic charging software 109a may perform the blockchain-based electronic currency automatic charging method according to an exemplary embodiment of the present disclosure. For example, the blockchain-based electronic currency automatic charging software 109a is loaded from the memory 103 and enables one or more processors 101 to execute an operation for determining, in response to a payment transaction processing request received from a payer terminal, whether an electronic currency held by the payer requires automatic charging, an operation for charging a predetermined amount of electronic currency in an electronic wallet of the payer when, as a result of the determination, it is determined that the electronic currency held by the payer requires automatic charging, an operation for creating a repayment transaction on the basis of payment information recorded in the payment transaction, the repayment transaction including a first electronic signature and a second electronic signature, wherein the first electronic signature is provided by the service providing server, and the second electronic signature is included in the payment information, and an operation for processing the repayment transaction by interoperating with the blockchain network formed of the plurality of blockchain nodes without requesting the payer terminal for an electronic signature for the repayment transaction.

The configuration and operation of the server providing server 100 according to an embodiment of the present disclosure has been described with reference to FIGS. 6 and 7. Next, the blockchain-based electronic currency automatic charging method according to an embodiment of the present disclosure will be described in detail with reference to FIGS. 8 to 12.

The steps of the blockchain-based electronic currency automatic charging method according to an embodiment of the present disclosure, which will be described below, may be performed by a computing apparatus. For example, the computing apparatus may be the service providing server 100 or another element constituting the blockchain-based electronic currency automatic charging system. For convenience of description, however, an operating entity of each of the steps included in the blockchain-based electronic currency automatic charging method may be omitted. Also, the steps of the blockchain-based electronic currency automatic charging method may be implemented by operations of a computer program executed by a processor.

FIG. 8 is a flowchart of the blockchain-based electronic currency automatic charging method according to an embodiment of the present disclosure. However, this is merely an exemplary embodiment for achieving an object of the present disclosure, and it will be appreciated that some steps may be included or excluded if necessary. Hereinafter, description will be given with reference to FIG. 8.

According to an embodiment of the present disclosure, a multiple-electronic signature technique is utilized to prevent requesting the payer for an electronic signature for a repayment transaction. When the multiple-electronic signature technique is utilized, only transactions including electronic signatures created by n (where n is a natural number equal to or greater than 2) or more private keys among m (where m is a natural number equal to or greater than 3) paired private keys may be treated as valid transactions. Hereinafter, to provide convenience in understanding, description will be given by assuming that m is “3,” and n is “2.”

To prevent requesting for an electronic signature for the repayment transaction, the service providing server 100 needs to acquire predetermined private keys or electronic signature information in advance. Therefore, in step S110, predetermined private keys or electronic signatures signed with the private keys are prestored in the service providing server 100. In this case, the private keys may be private keys of payers or private keys directly issued to the service providing server 100. That is, depending on the embodiment, entities and storage locations of three private keys used in multiple-electronic signature may be combined in various ways for each case. For example, in a first case, all of three private keys may be private keys of a payer, at least one of the private keys may be stored in a payer terminal, and at least one of the private keys may be stored in the service providing server 100. In a second case, one of three private keys may be a private key of the service providing server 100, and the service providing server 100 may store at least one private key including its private key (e.g., may store its private key and a private key of a payer). Various cases other than above may be present, and the scope of the present disclosure is not limited to specific cases.

FIG. 9A illustrates an example in which the service providing server 100 acquires an electronic signature. As illustrated in FIG. 9A, the service providing server 100 may acquire an electronic signature 511 by coercing a payer into signing an electronic signature when joining the automatic charging service. In such a case, a first private key 510 and/or a second private key 530, among three paired private keys, may be stored in the payer terminal 400, and the electronic signature 511 may be stored in the service providing server 100. Alternatively, as illustrated in FIG. 9B, a third private key 550, among the three paired private keys, may be prestored in the service providing server 100. The third private key 550 may be a private key of a payer or a private key of the service providing server 100. This may vary depending on the embodiment as desired. For example, in another embodiment, only the first private key 510 of the payer may be stored in the payer terminal 400, and the second private key 530 of the payer and the third private key 550 of the service providing server 100 may be stored in the service providing server 100.

Referring again to FIG. 8, in step S120, a request for processing a payment transaction including an electronic signature of the payer is received from the payer terminal 400. For example, as illustrated in FIG. 9C, the payer terminal 400 may transmit a payment transaction 570 including an electronic signature B 531 of the second private key 530 to the service providing server 100 and request for processing the payment transaction 570.

Referring again to FIG. 8, in step S130, in response to the request for processing the payment transaction, the service providing server 100 determines whether automatic charging is necessary. As described above, the service providing server 100 may use any one logic between a logic that interoperates with the blockchain network 300 and determines whether automatic charging is necessary or a logic that determines, by itself, whether automatic charging is necessary, and determine whether automatic charging is necessary. The description thereof will be omitted to avoid repetitive description.

In response to determination of whether automatic charging is necessary, in step S140, a predetermined amount of points is charged in an electronic wallet of the payer. Specifically, the service providing server 100 creates an automatic charging transaction, acquires a validity verification result for the automatic charging transaction through the block chain network 300, and then performs automatic charging. The detailed description thereof will be omitted to avoid repetitive description.

Here, the amount of points to be charged may be set as a difference between a payment amount and points held by a payer (i.e., shortfall of points). Alternatively, the amount of points to be charged may be set as a fixed amount regardless of the shortfall of points. Alternatively, the amount of points to be charged may be dynamically determined on the basis of the amount of commodity currency held (e.g., account balance or the like) by the payer.

In step S150, a repayment transaction is created on the basis of payment information included in the payment transaction. In this case, the payment information may include an electronic wallet address of a payer, an electronic wallet address of a payee, and a payment amount.

According to an embodiment of the present disclosure, as illustrated in FIG. 9C, a repayment transaction 590 may include the electronic signature B 531 included in the payment transaction 570 and an electronic signature C 551 signed with the third private key 550 prestored in the service providing server 100. In this embodiment, the electronic signature C 551 may be provided by the service providing server 100 itself. Therefore, the service providing server 100 may create (or initiate) and process the repayment transaction 590 by itself without requesting a payer for an electronic signature for the repayment transaction. Accordingly, convenience of a user using the automatic charging service may be improved.

Although an example in which two electronic signatures are included in the repayment transaction is shown in FIG. 9C, three electronic signatures may also be included therein. For example, two electronic signatures included in an existing payment transaction and a single electronic signature provided by the service providing server 100 (e.g., an electronic signature based on a prestored private key of a payer or an electronic signature based on a private key of the server) may be included in the repayment transaction. In another example, a single electronic signature included in an existing payment transaction and two electronic signatures provided by the service providing server 100 may be included in the repayment transaction. In this case, each of the two electronic signatures provided by the service providing server 100 may be based on any of a private key of the payer or a private key of the server.

According to an embodiment of the present disclosure, the repayment transaction may be created in two ways.

In one embodiment, the repayment transaction may include a first repayment transaction in which a payment amount of an existing payment transaction is changed into a first payment amount and a second repayment transaction in which a difference between the total payment amount and the first payment amount is set as a payment amount. To provide convenience in understanding, this will be additionally described with reference to FIG. 10.

FIG. 10 shows an example in which the total payment amount is 10,000 points, and 5,000 points is automatically charged due to insufficient balance.

Referring to FIG. 10, a repayment transaction 630 may include a first repayment transaction 631 in which a payment amount, 10,000 points, of an existing repayment transaction 610 is changed into 5,000 points and a second repayment transaction 633 about an additional payment amount, 5,000 points.

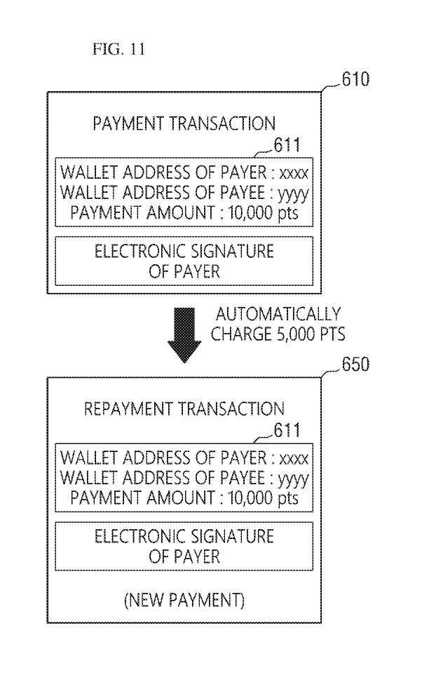

In one embodiment, the repayment transaction may be formed of a single new transaction. This will be additionally described with reference to FIG. 11. When the total payment amount is 10,000 points as above, the repayment transaction may be formed of a repayment transaction 650 that requests again for a payment of the total payment amount, 10,000 points.

Referring again to FIG. 8, in step S160, the repayment transaction is processed by interoperating with the blockchain network 300 formed of the plurality of blockchain nodes. The description on step S160 is the same as described above, and thus will be omitted to avoid repetitive description.

According to an embodiment of the present disclosure, a repayment transaction may be processed without utilizing the multiple-signature technique. For example, the service providing server 100 may prestore a private key, which is the same as that stored in the payer terminal 400, and use an electronic signature signed with the prestored private key to create a repayment transaction. Even according to this embodiment, convenience of a payer using the automatic charging service may be improved because intervention by the payer is not required.

The blockchain-based electronic currency automatic charging method according to an embodiment of the present disclosure has been described with reference to FIGS. 8 to 11. According to the above description, even when automatic charging is performed and a repayment transaction is created, an electronic signature of a payer may not be requested again. In this way, a problem of low user convenience due to a repetitive request for an electronic signature may be solved.

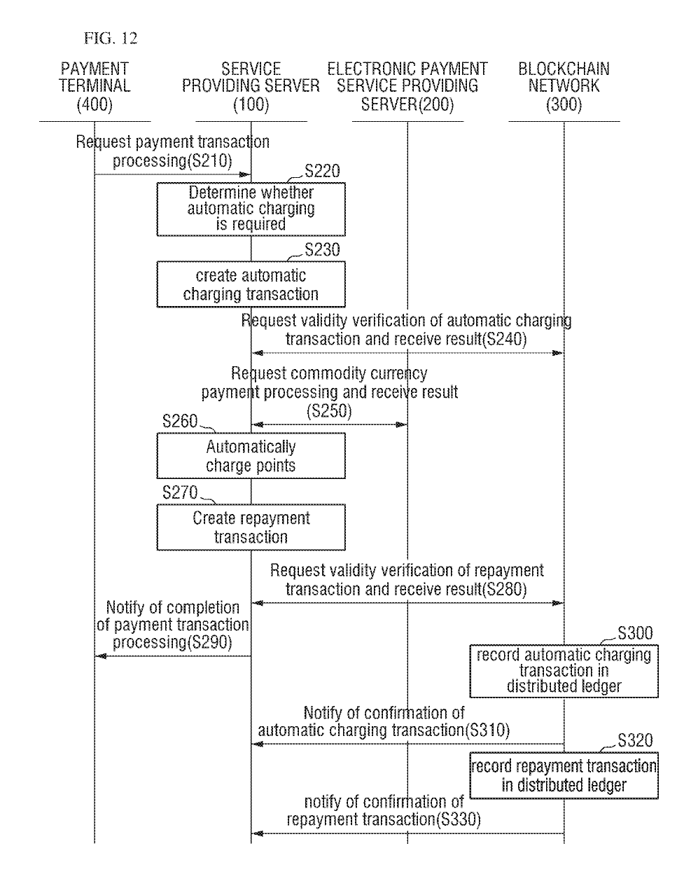

The electronic currency automatic charging method according to an embodiment of the present disclosure has been described from the viewpoint of the service providing server 100 with reference to FIG. 8. Hereinafter, to provide further convenience in understanding, the electronic currency automatic charging method according to an embodiment of the present disclosure will be described from the viewpoint of the blockchain-based electronic currency automatic charging system with reference to FIG. 12. To avoid repetitive description, description of parts which are the same as described above will be omitted.

Referring to FIG. 12, in step S210, the service providing server 100 receives a payment transaction processing request from the payer terminal 400 (S210). Step S210 and S290 form a portion of a payment transaction form the point of view of payment terminal 400.

In step S220, in response to the processing request, the service providing server 100 determines whether automatic charging is necessary.

In response to the determination of whether automatic charging is necessary, in step S230, the service providing server 100 creates an automatic charging transaction (S230). For example, the service providing server 100 may use an electronic wallet address of the payer included in a payment transaction and a predetermined electronic wallet address of a system and create the automatic charging transaction. The amount of points to be charged may vary depending on the embodiment.

In step S240, the service providing server 100 requests the blockchain network 300 for validity verification of the automatic charging transaction, and receives a validity verification result corresponding to the request (S240).

In response to receiving a verification result that indicates that the automatic charging transaction is valid, in step S250, the service providing server 100 requests the electronic payment service providing server 200 for processing payment with a commodity currency, and receives a payment processing result corresponding to the request.

When the payment with the commodity current is normally processed, in step S260, the service providing server 100 automatically charges points.

When the automatic charging of the points is completed, in step S270, the service providing server 100 creates a repayment transaction. Specifically, the service providing server 100 uses payment information included in a payment transaction, a first electronic signature included in an existing payment transaction, and a second electronic signature provided by itself and creates the repayment transaction. Step S270, S280 and S330 form a portion of a repayment transaction form the point of view of the service providing server 100.

In step S280, the service providing server 100 requests the blockchain network 300 for validity verification of the repayment transaction, and receives a verification result corresponding to the request.

In response to receiving a verification result that indicates that the repayment transaction is valid, in step S290, the service providing server 100 performs point deduction processing according to the payment transaction and sends a message notifying of payment processing completion, which indicates approval of payment, to the payer terminal 400.

In step S300, data for the automatic charging transaction is recorded in blockchain data managed by each of the plurality of blockchain nodes, and in step S310, the service providing server 100 receives a notification that the automatic charging transaction is confirmed.

In step S320, data for the repayment transaction is recorded in blockchain data managed by each of the plurality of blockchain nodes, and in step S330, the service providing server 100 receives a notification that the repayment transaction is confirmed.

As reference, although it is shown in FIG. 12 that step S300 is performed after step S260, this merely reflects that a predetermined amount of time is generally required for block creation, and does not mean that a particular order exists between the two steps S300 and S260. As described above, steps S260 and S300 may be performed in parallel after the automatic charging transaction is verified. Due to the same reason, steps S290 and S320 may also be performed in parallel.

The procedure in which the electronic currency automatic charging method according to an embodiment of the present disclosure is performed has been described from the viewpoint of the blockchain-based electronic currency automatic charging system with reference to FIG. 12.

According to the present disclosure, an electronic signature for a repayment transaction can be automatically performed using a secret key of a payer prestored in a service providing server. With this, even when a repayment transaction occurs due to automatic charging, the repayment transaction can be processed through a blockchain system without requesting for an electronic signature of a payer. Therefore, user convenience can be improved, and user satisfaction in using an automatic charging service can be enhanced.

Further, an automatic charging transaction and a repayment transaction can be immediately processed on the basis of reliability secured in advance through a permission-based blockchain network. Accordingly, the problem of low user convenience due to generation of lead time can be solved.

It should be noted that effects of the present disclosure are not limited to the above-described effects, and other effects of the present disclosure will be apparent to those skilled in the art from the following descriptions.

The concepts of the invention described above with reference to FIGS. 3 to 12 can be embodied as computer-readable code on a computer-readable medium. The computer-readable medium may be, for example, a removable recording medium (a CD, a DVD, a Blu-ray disc, a USB storage apparatus, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A blockchain-based electronic currency automatic charging method, the blockchain-based electronic currency automatic charging method comprising:
determining that an automatic charging of a charging amount of electronic currency to a payer is necessary, in response to receiving a payment transaction processing request from a terminal of the payer, wherein the payment transaction processing request is associated with a payment transaction and wherein the payment transaction processing request includes payment information;
charging the charging amount of electronic currency in an electronic wallet of the payer in response to the determining;
initiating a repayment transaction based on the payment information, wherein a repayment transaction message is associated with the repayment transaction, and wherein the repayment transaction message includes a first electronic signature and a second electronic signature, and wherein the first electronic signature is provided by a service-providing server, and wherein the second electronic signature is obtained from the payment information; and
processing the repayment transaction without requesting the terminal of the payer for an electronic signature for the repayment transaction message, wherein the processing includes interoperating with a blockchain network formed of a plurality of blockchain nodes.

2. The blockchain-based electronic currency automatic charging method of claim 1, wherein the determining comprises:
referring the payment transaction to the blockchain network and acquiring a verification result for the payment transaction; and
determining, based on the verification result, that the automatic charging is necessary.

3. The blockchain-based electronic currency automatic charging method of claim 1, wherein the determining comprises:
before referring the payment transaction to the blockchain network, checking a balance of an electronic wallet of the payer; and
determining that the automatic charging is necessary based on the balance.

4. The blockchain-based electronic currency automatic charging method of claim 1, wherein the initiating the repayment transaction comprises:
changing a payment amount included in the payment information into a first payment amount;
changing the payment transaction into a first repayment transaction; and
initiating a second repayment transaction based on a difference between the first payment amount and the charging amount.

5. The blockchain-based electronic currency automatic charging method of claim 1, wherein the initiating the repayment transaction comprises:
continuing no further with the payment transaction; and
associating the repayment transaction with the same amount as a payment amount included in the payment information.

6. The blockchain-based electronic currency automatic charging method of claim 1, wherein the charging of the charging amount of electronic currency comprises:
initiating an automatic charging transaction for the charging amount of electronic currency;
referring the automatic charging transaction to a first blockchain node of the plurality of blockchain nodes;
receiving a verification result for the automatic charging transaction from the first blockchain node;
when the verification result indicates a valid transaction:
performing a first process of allowing payment processing with a commodity currency to be performed through an electronic payment service-providing server and acquiring a payment processing result of the payment processing with the commodity currency from the electronic payment service-providing server; and
when the payment processing result indicates a normal processing with the commodity currency:
performing a second process of charging the charging amount of electronic currency in the electronic wallet of the payer, and
performing, by a second blockchain node of the plurality of blockchain nodes, a third process of:
recording data for the automatic charging transaction in blockchain data, and
spreading the recorded data over the blockchain network.

7. The blockchain-based electronic currency automatic charging method of claim 6, wherein the second process and the third process are performed in parallel.

8. The blockchain-based electronic currency automatic charging method of claim 1, wherein the processing the repayment transaction comprises:
performing a first process of referring the repayment transaction to a first blockchain node of the plurality of blockchain nodes and acquiring a verification result for the repayment transaction from the first blockchain node; and
when the verification result for the repayment transaction indicates a valid transaction:
performing a second process that allows a second amount of electronic currency to be transferred from an electronic wallet of the payer to an electronic wallet of a payee according to the repayment transaction, and
performing, by a second blockchain node of the plurality of blockchain nodes, a third process of recording data for the repayment transaction in blockchain data distributed and managed by the plurality of blockchain nodes, wherein the second process and the third process are performed in parallel.

9. The blockchain-based electronic currency automatic charging method of claim 8, wherein the blockchain network is a permission-based blockchain network in which only permitted payers and permitted blockchain nodes participate.

10. The blockchain-based electronic currency automatic charging method of claim 9, wherein:
the plurality of blockchain nodes distribute and store first blockchain data in which a plurality of first blockchain blocks are connected in a chain structure and second blockchain data in which a plurality of second blockchain blocks are configured separately from the first blockchain data, and
the first blockchain data includes permission information on the payers and the blockchain nodes, and
the second blockchain data includes transaction data.

11. The blockchain-based electronic currency automatic charging method of claim 8, wherein the performing the third process comprises:
creating a new block through a mining process;
recording, in the new block, data for the repayment transaction and permission information of the second blockchain node; and
spreading the new block over the blockchain network,
wherein a third blockchain node among the plurality of blockchain nodes receives the new block and determines whether to add the new block based on a result of a comparison between permission information of a block-creating blockchain node prestored in the blockchain data and based on permission information of the second blockchain node recorded in the new block.

12. A service-providing server comprising:
a hardware processor;
a network interface;
a memory configured to load a computer program to be executed by the hardware processor; and
a storage configured to store the computer program,
wherein the computer program which, when executed by the hardware processor, causes the hardware processor to perform operations comprising:
determining that an automatic charging of a charging amount of electronic currency held by a payer is necessary, in response to a payment transaction processing request received from a terminal of the payer, wherein the payment transaction processing request is associated with a payment transaction and wherein the payment transaction processing request includes payment information;
charging the charging amount of electronic currency in an electronic wallet of the payer in response to the determining;
initiating a repayment transaction based on the payment information, wherein a repayment transaction message is associated with the repayment transaction, and wherein the repayment transaction message includes a first electronic signature and a second electronic signature, and wherein the first electronic signature is provided by the service-providing server, and wherein the second electronic signature is obtained from the payment transaction; and
processing the repayment transaction without requesting the terminal of the payer for an electronic signature for the repayment transaction message, wherein the processing includes interoperating with a blockchain network formed of a plurality of blockchain nodes.

13. The service-providing server of claim 12, wherein the determining includes:
referring the payment transaction to the blockchain network and acquiring a verification result for the payment transaction; and
determining, based on the verification result, whether the automatic charging is necessary.

14. The service-providing server of claim 12, wherein the determining includes:
checking a balance of an electronic wallet of the payer before the payment transaction is transferred to the blockchain network; and
determining, based on the balance, that the automatic charging is necessary.

15. The service-providing server of claim 12, wherein the initiating the repayment transaction includes:
changing a payment amount included in the payment information into a first payment amount and changing the payment transaction into a first repayment transaction; and
initiating a second repayment transaction based on a difference between the charging amount and the first payment amount.

16. The service-providing server of claim 12, wherein the initiating the repayment transaction includes:
continuing no further with the payment transaction; and
associating the repayment transaction having the same payment amount as a payment amount included in the payment information.

17. The service-providing server of claim 12, wherein the charging of the charging amount of electronic currency in the electronic wallet of the payer includes:
initiating an automatic charging transaction for the charging amount of electronic currency;
referring the automatic charging transaction to a first blockchain node of the plurality of blockchain nodes and receiving a verification result for the automatic charging transaction from the first blockchain node;
when the verification result indicates a valid transaction, performing a first process of allowing payment processing with a commodity currency to be performed through an electronic payment service-providing server and acquiring a payment processing result from the electronic payment service-providing server; and
when the payment processing result indicates a normal processing with the commodity currency, performing a second process of charging the charging amount of electronic currency in the electronic wallet of the payer.

18. The service-providing server of claim 12, wherein the processing the repayment transaction includes:
performing a first process of referring the repayment transaction to a first blockchain node of the plurality of blockchain nodes and acquiring a verification result for the repayment transaction from the first blockchain node; and
when the verification result for the repayment transaction indicates a valid transaction, performing a second process that allows a second amount of electronic currency to be transferred from an electronic wallet of the payer to an electronic wallet of a payee according to the repayment transaction.

19. The service-providing server of claim 18, wherein the blockchain network is a permission-based blockchain network in which only permitted payers and permitted blockchain nodes participate.

20. A non-transitory computer-readable storage medium storing a computer program which, when executed by at least one processor of a service-providing server, causes the service-providing server to perform operations comprising:
determining that an automatic charging of a charging amount of electronic currency to a payer is necessary, in response to a payment transaction processing request received from a terminal of the payer, wherein the payment transaction processing request is associated with a payment transaction and wherein the payment transaction processing request includes payment information;
charging the charging amount of electronic currency in an electronic wallet of the payer in response to the determining;
initiating a repayment transaction based on payment information, where a repayment transaction message is associated with the repayment transaction, and wherein the repayment transaction message includes a first electronic signature and a second electronic signature, and wherein the first electronic signature is provided by the service-providing server, and the second electronic signature is obtained from the payment information; and
processing the repayment transaction without requesting the terminal of the payer for an electronic signature for the repayment transaction, wherein the processing includes interoperating with a blockchain network formed of a plurality of blockchain nodes.
